(19) United States
(12) Patent Application Publication
(10) Pub. No.: US 2013/0272428 A1
(43) Pub. Date: Oct. 17, 2013

(54) VIDEO DECODER FOR COPY SLICES

(71) Applicant: Sachin G. DESHPANDE, Camas, WA (US)

(72) Inventor: Sachin G. DESHPANDE, Camas, WA (US)

(73) Assignee: SHARP LABORATORIES OF AMERICA, INC., Camas, WA (US)

(21) Appl. No.: 13/448,189

(22) Filed: Apr. 16, 2012

(51) Int. Cl. H04N 7/26

(52) U.S. Cl. 375/240.25; 375/E07.027

(57) ABSTRACT

A system for decoding video includes receiving a frame of the video in a bitstream that includes at least one slice and at least one tile. At least one slice and at least one tile are not all aligned with one another, and each of the at least one slice is characterized that it is decoded independently of the other at least one slice. The at least one tile is characterized that it is a rectangular region of the frame and having coding units for the decoding arranged in a raster scan order, and wherein the at least one tile of the frame are collectively arranged in a raster scan order of the frame. The system receives slice header data for at least one slice in the bitstream indicating that the pixel data of the slice is obtained from corresponding pixel locations in a different frame than the frame including the at least one slice.

### CROSS-REFERENCE TO RELATED APPLICATIONS

None.

### BACKGROUND OF THE INVENTION

The present invention relates to video encoding and decoding.

Digital video is typically represented as a series of images or frames, each of which contains an array of pixels. Each pixel includes information, such as intensity and/or color information. In many cases, each pixel is represented as a set of three colors, each of which is defined by eight bit color values.

Video-coding techniques, for example H.264/MPEG-4 AVC (H.264/AVC), typically provide higher coding efficiency at the expense of increasing complexity. Increasing image quality requirements and increasing image resolution requirements for video coding techniques also increase the coding complexity. Video decoders that are suitable for parallel decoding may improve the speed of the decoding process and reduce memory requirements; video encoders that are suitable for parallel encoding may improve the speed of the encoding process and reduce memory requirements.

H.264/MPEG-4 AVC [Joint Video Team of ITU-T VCEG and ISO/IEC MPEG, “H.264: Advanced video coding for generic audiovisual services,” ITU-T Rec. H.264 and ISO/IEC 14496-10 (MPEG4—Part 10), November 2007], and similarly the JCT-VC, [“Draft Test Model Under Consideration”, JCTVC-A205, JCT-VC Meeting, Dresden, April 2010 (JCT-VC)], both of which are incorporated by reference herein in their entirety, are video codec (encoder/decoder) specifications that use macroblock prediction followed by residual coding to reduce temporal and spatial redundancy in a video sequence for compression efficiency.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a H.264/AVC video encoder.

FIG. 2 illustrates a H.264/AVC video decoder.

FIG. 3 illustrates an exemplary slice structure.

FIG. 4 illustrates another exemplary slice structure.

FIG. 5 illustrates reconstruction of an entropy slice.

FIG. 6 illustrates parallel reconstruction of an entropy slice.

FIG. 7 illustrates a frame with a slice and 9 tiles.

FIG. 8 illustrates a frame with three slices and 3 tiles.

FIG. 9 illustrates a copy slice technique.

FIG. 10 illustrates copying a slice.

FIG. 11 illustrates copying corresponding slice pixel data.

### DETAILED DESCRIPTION OF PREFERRED EMBODIMENT

While any video coder/decoder (codec) that uses entropy encoding/decoding may be accommodated by embodiments described herein, exemplary embodiments are described in relation to an H.264/AVC encoder and an H.264/AVC decoder merely for purposes of illustration. Many video coding techniques are based on a block-based hybrid video-coding approach, wherein the source-coding technique is a hybrid of inter-picture, also considered inter-frame, prediction, intra-picture, also considered intra-frame, prediction and transform coding of a prediction residual. Inter-frame prediction may exploit temporal redundancies, and intra-frame and transform coding of the prediction residual may exploit spatial redundancies.

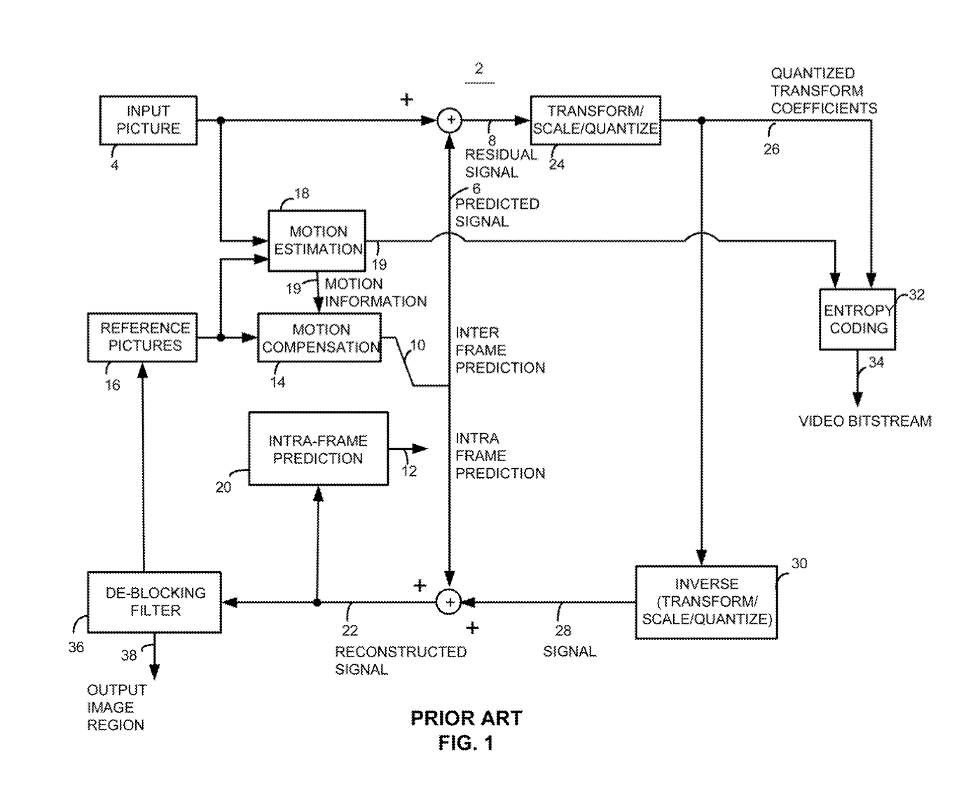

FIG. 1 illustrates an exemplary H.264/AVC video encoder 2. An input picture 4, also considered a frame, may be presented for encoding. A predicted signal 6 and a residual signal 8 may be produced, wherein the predicted signal 6 may be based on either an inter-frame prediction 10 or an intra-frame prediction 12. The inter-frame prediction 10 may be determined by motion compensation 14 one or more stored, reference pictures 16, also considered reference frames, using motion information 19 determined by a motion estimation 18 process between the input frame 4 and the reference frames 16. The intra-frame prediction 12 may be determined 20 using a reconstructed signal 22. The residual signal 8 may be determined by subtracting the input frame 4 from the predicted signal 6. The residual signal 8 is transformed, scaled and quantized 24, thereby producing quantized, transform coefficients 26. The reconstructed signal 22 may be generated by adding the predicted signal 6 to a signal 28 generated by inverse transforming, scaling and inverse quantizing 30 the quantized, transform coefficients 26. The motion information 19 and the quantized, transform coefficients 26 may be entropy coded 32 and written to the compressed-video bitstream 34. An output image region 38, for example a portion of the reference frame, may be generated at the encoder 2 by filtering 36 the reconstructed, pre-filtered signal 22. This output frame may be used as a reference frame for the encoding of subsequent input pictures.

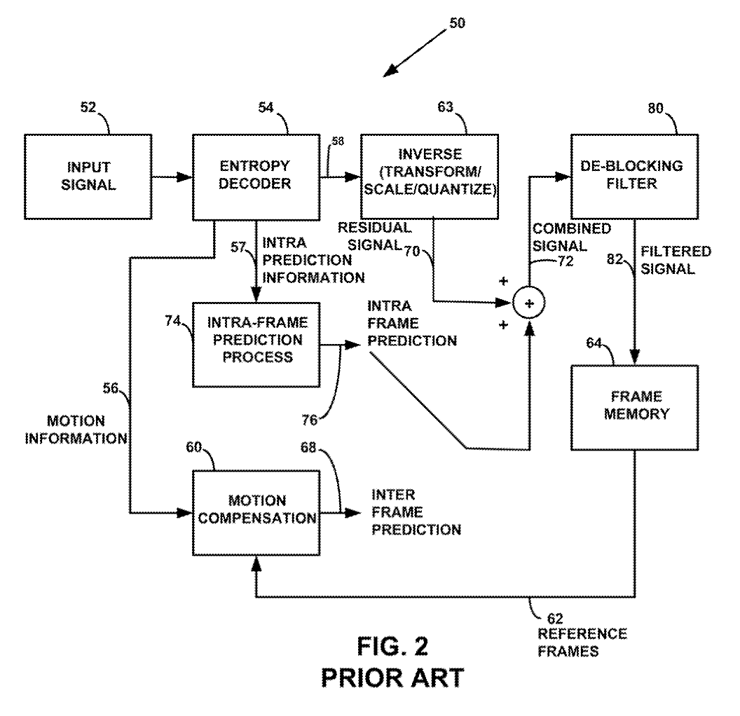

FIG. 2 illustrates an exemplary H.264/AVC video decoder 50. An input signal 52, also considered a bitstream, may be presented for decoding. Input signal 52 may be sent to entropy decoder 54, thereby producing motion information 56, intra-prediction information 57, and quantized, scaled, transform coefficients 58. The motion information 56 may be combined 60 with a portion of one or more reference frames 62 which may reside in frame memory 64, and an inter-frame prediction 68 may be generated. The quantized, scaled, transform coefficients 58 may be inverse quantized, scaled and inverse transformed 63, thereby producing a decoded residual signal 70. The residual signal 70 may be added to a prediction signal: either the inter-frame prediction signal 68 or an intra-frame prediction signal 76. The intra-frame prediction information 57 may be combined with previously decoded information in the current frame by an intra-frame prediction process 74, and an intra-frame prediction 76 may be generated. A combined signal 72 may be filtered with a deblocking filter 80 and the filtered signal 82 may be written to the frame memory 64.

In H.264/AVC, an input picture may be partitioned into fixed-size macroblocks, wherein each macroblock covers a rectangular picture area of 16×16 samples of the luma component and 8×8 samples of each of the two chroma components. The decoding process of the H.264/AVC standard is specified for processing units which are macroblocks. The entropy decoder 54 parses the syntax elements of the input signal 52 and de-multiplexes them. H.264/AVC specifies two alternative methods of entropy decoding: a low-complexity technique that is based on the usage of context-adaptively switched sets of variable length codes, referred to as CAVLC, and the computationally more demanding technique of context-based adaptively binary arithmetic coding, referred to as CABAC. In both such entropy decoding techniques, decoding of a current symbol may rely on previously, correctly decoded symbols and adaptively updated context models. In addition, different data information, for example, prediction data information, residual data information and different color planes, may be multiplexed together. De-multiplexing may wait until elements are entropy decoded.

After entropy decoding, a macroblock may be reconstructed by obtaining: the residual signal through inverse quantization and the inverse transform, and the prediction signal, either the intra-frame prediction signal or the inter-frame prediction signal. Blocking distortion may be reduced by applying a de-blocking filter to decoded macroblocks. Typically, such subsequent processing begins after the input signal is entropy decoded, thereby resulting in entropy decoding as a potential bottleneck in decoding. Similarly, in codecs in which alternative prediction mechanisms are used, for example, inter-layer prediction in H.264/AVC or inter-layer prediction in other scalable codecs, entropy decoding may be requisite prior to processing at the decoder, thereby making entropy decoding a potential bottleneck.

An input picture comprising a plurality of macroblocks may be partitioned into one or several slices. The values of the samples in the area of the picture that a slice represents may be properly decoded without the use of data from other slices provided that the reference pictures used at the encoder and the decoder are the same and that de-blocking filtering does not use information across slice boundaries. Therefore, entropy decoding and macroblock reconstruction for a slice does not depend on other slices. In particular, the entropy coding state may be reset at the start of each slice. The data in other slices may be marked as unavailable when defining neighborhood availability for both entropy decoding and reconstruction. The slices may be entropy decoded and reconstructed in parallel. No intra prediction and motion-vector prediction is preferably allowed across the boundary of a slice. In contrast, de-blocking filtering may use information across slice boundaries.

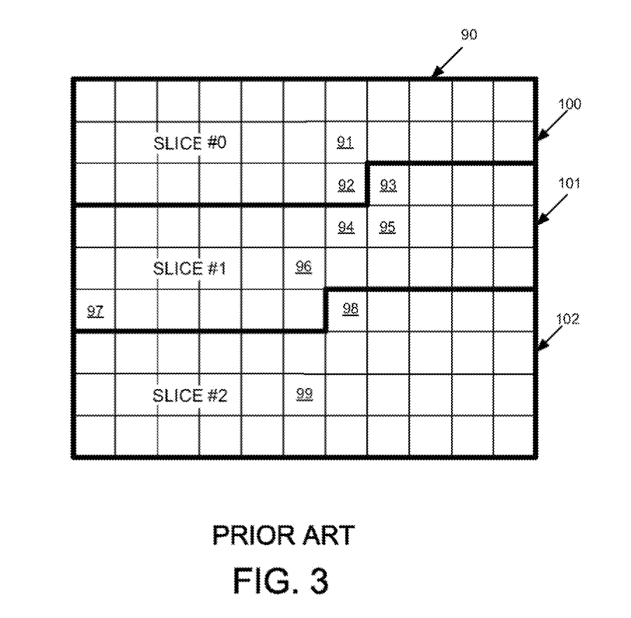

FIG. 3 illustrates an exemplary video picture 90 comprising eleven macroblocks in the horizontal direction and nine macroblocks in the vertical direction (nine exemplary macroblocks labeled 91-99). FIG. 3 illustrates three exemplary slices: a first slice denoted “SLICE #0” 100, a second slice denoted “SLICE #1” 101 and a third slice denoted “SLICE #2” 102. An H.264/AVC decoder may decode and reconstruct the three slices 100, 101, 102 in parallel. Each of the slides may be transmitted in scan line order in a sequential manner. At the beginning of the decoding/reconstruction process for each slice, context models are initialized or reset and macroblocks in other slices are marked as unavailable for both entropy decoding and macroblock reconstruction. Thus, for a macroblock, for example, the macroblock labeled 93, in “SLICE #1,” macroblocks (for example, macroblocks labeled 91 and 92) in “SLICE #0” may not be used for context model selection or reconstruction. Whereas, for a macroblock, for example, the macroblock labeled 95, in “SLICE #1,” other macroblocks (for example, macroblocks labeled 93 and 94) in “SLICE #1” may be used for context model selection or reconstruction. Therefore, entropy decoding and macroblock reconstruction proceeds serially within a slice. Unless slices are defined using a flexible macroblock ordering (FMO), macroblocks within a slice are processed in the order of a raster scan.

Flexible macroblock ordering defines a slice group to modify how a picture is partitioned into slices. The macroblocks in a slice group are defined by a macroblock-to-slice-group map, which is signaled by the content of the picture parameter set and additional information in the slice headers. The macroblock-to-slice-group map consists of a slice-group identification number for each macroblock in the picture. The slice-group identification number specifies to which slice group the associated macroblock belongs. Each slice group may be partitioned into one or more slices, wherein a slice is a sequence of macroblocks within the same slice group that is processed in the order of a raster scan within the set of macroblocks of a particular slice group. Entropy decoding and macroblock reconstruction proceeds serially within a slice group.

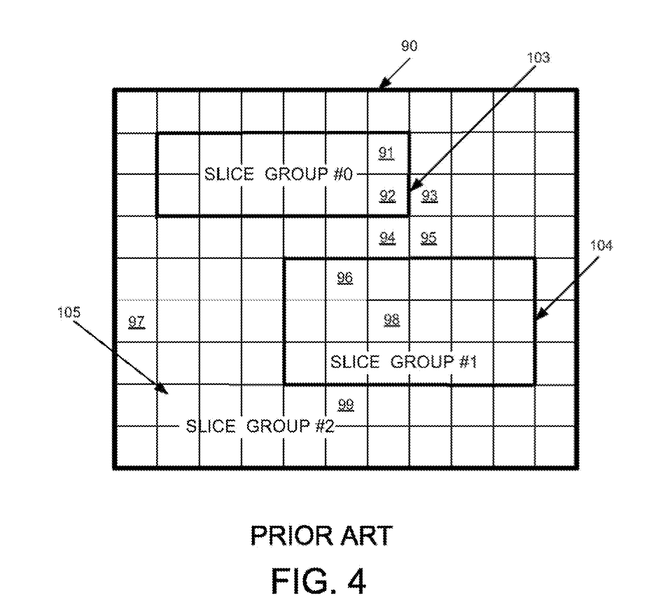

FIG. 4 depicts an exemplary macroblock allocation into three slice groups: a first slice group denoted “SLICE GROUP #0” 103, a second slice group denoted “SLICE GROUP #1” 104 and a third slice group denoted “SLICE GROUP #2” 105. These slice groups 103, 104, 105 may be associated with two foreground regions and a background region, respectively, in the picture 90.

A picture may be partitioned into one or more reconstruction slices, wherein a reconstruction slice may be self-contained in the respect that values of the samples in the area of the picture that the reconstruction slice represents may be correctly reconstructed without use of data from other reconstruction slices, provided that the references pictures used are identical at the encoder and the decoder. All reconstructed macroblocks within a reconstruction slice may be available in the neighborhood definition for reconstruction.

A reconstruction slice may be partitioned into more than one entropy slice, wherein an entropy slice may be self-contained in the respect that symbol values in the area of the picture that the entropy slice represents may be correctly entropy decoded without the use of data from other entropy slices. The entropy coding state may be reset at the decoding start of each entropy slice. The data in other entropy slices may be marked as unavailable when defining neighborhood availability for entropy decoding. Macroblocks in other entropy slices may not be used in a current block's context model selection. The context models may be updated only within an entropy slice. Accordingly, each entropy decoder associated with an entropy slice may maintain its own set of context models.

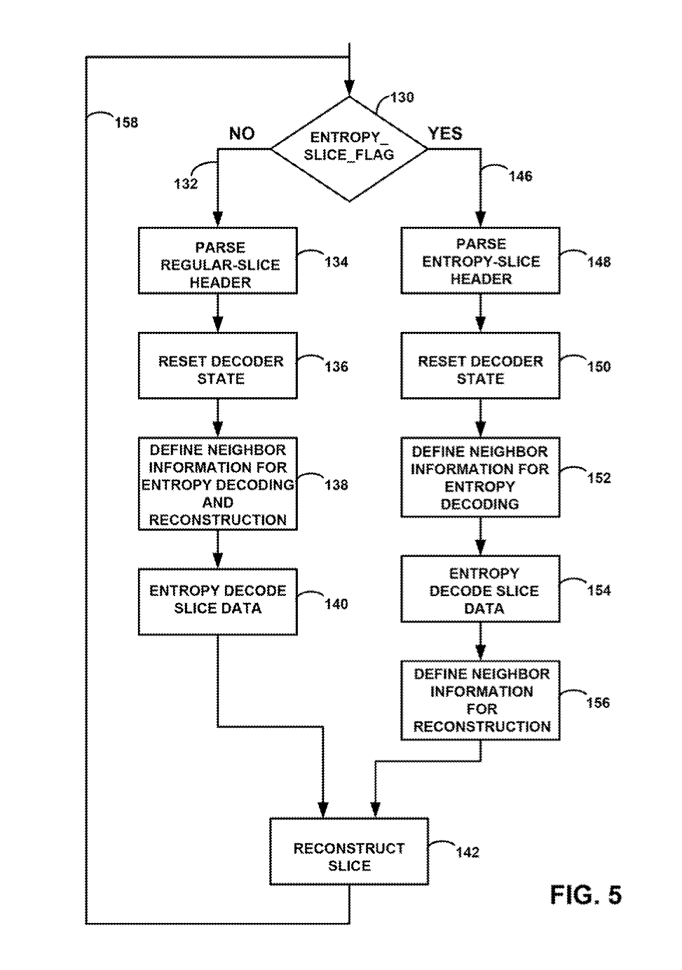

An encoder may determine whether or not to partition a reconstruction slice into entropy slices, and the encoder may signal the decision in the bitstream. The signal may comprise an entropy-slice flag, which may be denoted “entropy_slice_flag”. Referring to FIG. 5, an entropy-slice flag may be examined 130, and if the entropy-slice flag indicates that there are no 132 entropy slices associated with a picture, or a reconstruction slice, then the header may be parsed 134 as a regular slice header. The entropy decoder state may be reset 136, and the neighbor information for the entropy decoding and the reconstruction may be defined 138. The slice data may then be entropy decoded 140, and the slice may be reconstructed 142. If the entropy-slice flag indicates there are 146 entropy slices associated with a picture, or a reconstruction slice, then the header may be parsed 148 as an entropy-slice header. The entropy decoder state may be reset 150, the neighbor information for entropy decoding may be defined 152 and the entropy-slice data may be entropy decoded 154. The neighbor information for reconstruction may then be defined 156, and the slice may be reconstructed 142. After slice reconstruction 142, the next slice, or picture, may be examined 158.

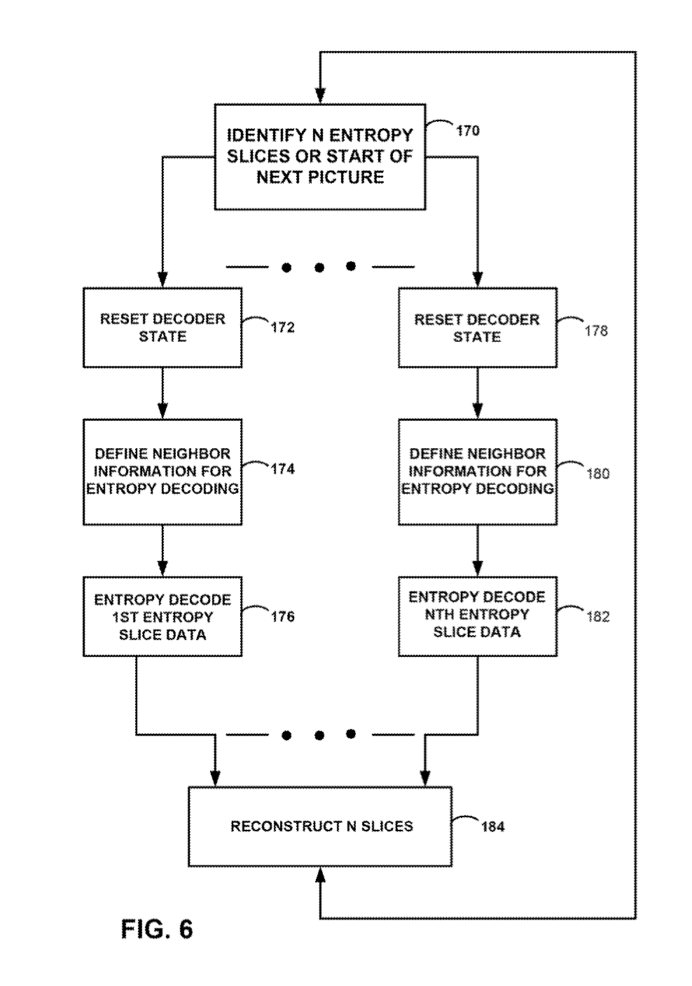

Referring to FIG. 6, the decoder may be capable of parallel decoding and may define its own degree of parallelism, for example, consider a decoder comprising the capability of decoding N entropy slices in parallel. The decoder may identify 170 N entropy slices. If fewer than N entropy slices are available in the current picture, or reconstruction slice, the decoder may decode entropy slices from subsequent pictures, or reconstruction slices, if they are available. Alternatively, the decoder may wait until the current picture, or reconstruction slice, is completely processed before decoding portions of a subsequent picture, or reconstruction slice. After identifying 170 up to N entropy slices, each of the identified entropy slices may be independently entropy decoded. A first entropy slice may be decoded 172-176. The decoding 172-176 of the first entropy slice may comprise resetting the decoder state 172. If CABAC entropy decoding is used, the CABAC state may be reset. The neighbor information for the entropy decoding of the first entropy slice may be defined 174, and the first entropy slice data may be decoded 176. For each of the up to N entropy slices, these steps may be performed (178-182 for the Nth entropy slice). The decoder may reconstruct 184 the entropy slices when all, or a portion of, the entropy slices are entropy decoded.

When there are more than N entropy slices, a decode thread may begin entropy decoding a next entropy slice upon the completion of entropy decoding of an entropy slice. Thus when a thread finishes entropy decoding a low complexity entropy slice, the thread may commence decoding additional entropy slices without waiting for other threads to finish their decoding.

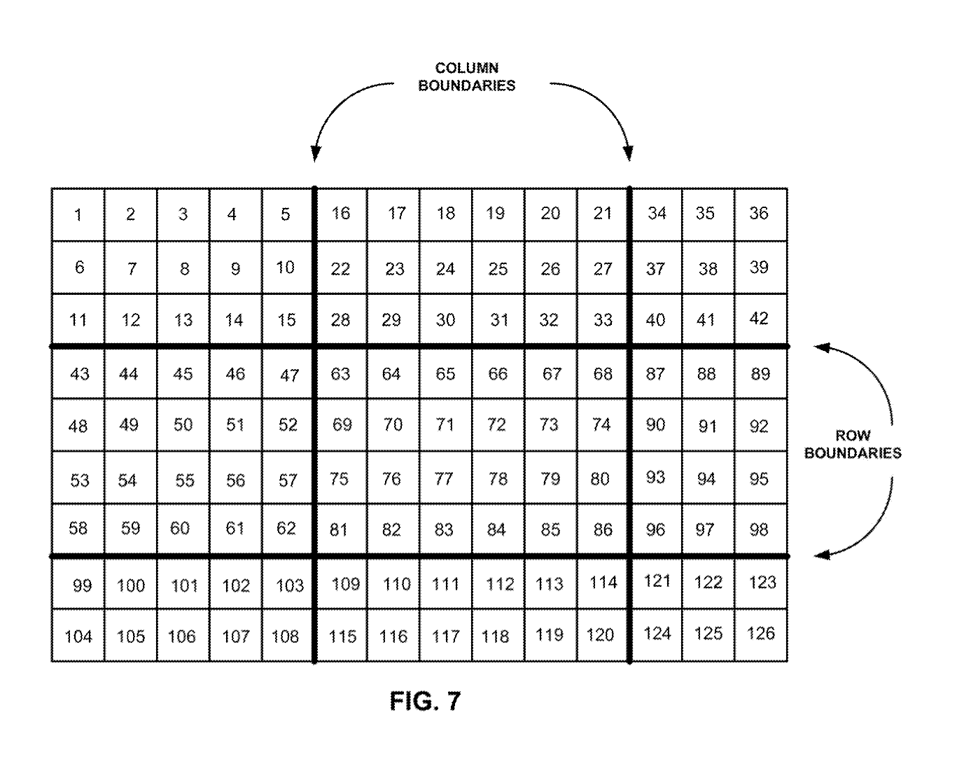

Referring to FIG. 7, a tile technique divides an image into a set of rectangular (inclusive of square) regions. The macroblocks (e.g., largest coding units) within each of the tiles are encoded and decoded in a raster scan order. The arrangement of tiles are likewise encoded and decoded in a raster scan order. Accordingly, there may be any suitable number of column boundaries (e.g., 0 or more) and there may be any suitable number of row boundaries (e.g., 0 or more). Thus, the frame may define one or more slices, such as the one slice illustrated in FIG. 7. In some embodiments, macroblocks located in different tiles are not available for intra-prediction, motion compensation, entropy coding context selection or other processes that rely on neighboring macroblock information.

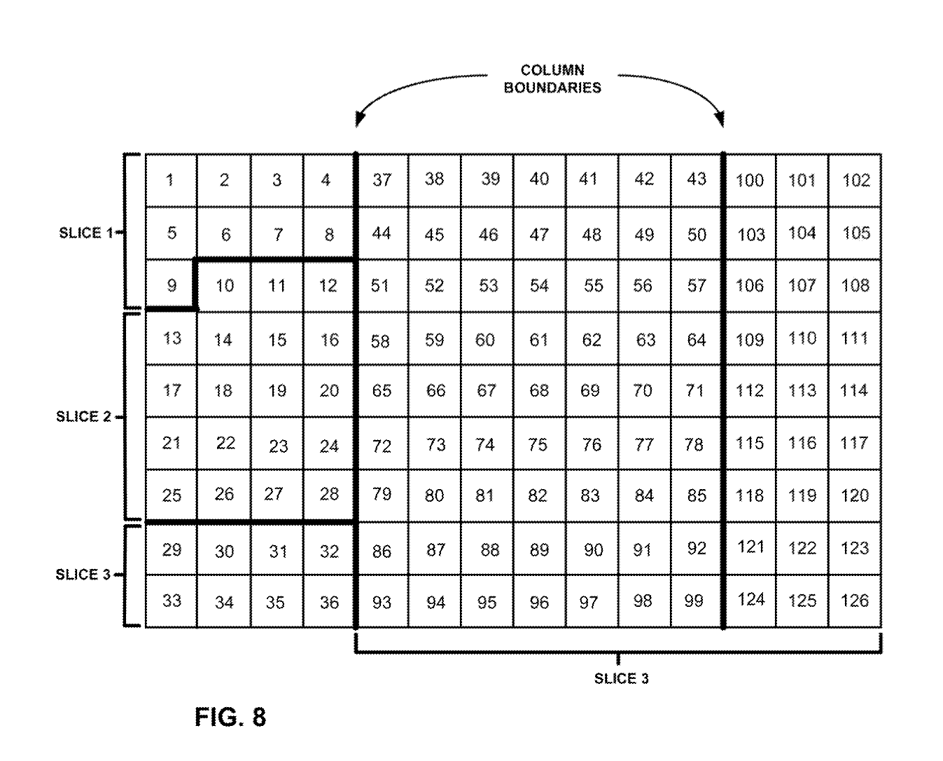

Referring to FIG. 8, the tile technique is shown dividing an image into a set of three rectangular columns. The macroblocks (e.g., largest coding units) within each of the tiles are encoded and decoded in a raster scan order. The tiles are likewise encoded and decoded in a raster scan order. One or more slices may be defined in the scan order of the tiles. Each of the slices are independently decodable. For example, slice 1 may be defined as including macroblocks 1-9, slice 2 may be defined as including macroblocks 10-28, and slice 3 may be defined as including macroblocks 29-126 which spans three tiles. The use of tiles facilitates coding efficiency by processing data in more localized regions of a frame.

Different slices may be encoded and/or decoded using several different techniques. One type of encoding and/or decoding for a slice is using an intra-coded slice which is encoded, with no reference to past or future slices (e.g., I slice). Another type of encoding and/or decoding for a slice is using a predictive technique (e.g., P slice). The P-slice is a slice of the frame encoded relative to past reference slices. The reference slice may be another P slice or an I slice. Another type of encoding and/or decoding for a slice is using a bidirectional predicted slice, based on both previous and following slices (e.g., B slice). The B slices typically use the least number of bits, compared to a P slice or an I slice. The bitstream may explicitly and/or implicitly signal the encoding and/or decoding technique for the slice (e.g., slice_type).

Often for news broadcasts or financial broadcasts, there is a static background that is substantially unchanged for a significant number of frames, while there are one or more windows having moving content that changes regularly, such as on a frame by frame basis. In this case, the encoding and decoding may encode and decode, respectively, the static portions of the video content using one or more slices, while encoding and decoding the non-static portions of the video content using other slices. This provides some enhanced coding efficiency by suitable selection of the location of the slices. To further increase the coding efficiency, a copy slice data technique from another frame may be included as one of the available types of slices for encoding and/or decoding.

For video sequences that have relatively slow motion, the use of C-slices (described later) may be suitable for encoding the video in a manner which increases the coding efficiency. In such a case, some or all of the frames may be repeated.

For video sequences where the frame rate is desired to be at a higher rate, such as from 60 hertz to 120 hertz, the C-slices (described later) may be used to efficiently encode the additional frames or parts thereof.

Another type of encoding and/or decoding for a slice is using a copy technique (e.g., C slice). The C-slice is a slice of the frame where the pixels of the slice are determined by being copied from another frame at the same pixel locations. The copied pixel data for a C-slice may be from a previous frame or a future frame in output order. In some cases, the corresponding slices of different frames will tend to shift as a result of alignment issues, therefore it is preferred that the pixel data of the C-slice is a copy of the pixel data from another frame at the same pixel locations, rather than attempting to copy the data of a corresponding slice which may not be suitably aligned. Thus, in those cases that a pair of corresponding slices of different pictures are not aligned with one another, the C-slice technique will copy the pixel data without regard to the positioning of the corresponding slice (if any). The number of bits required for encoding a video, by using the C-slice technique for portions of the video, can result in a reduction in the overall bit rate as opposed to other encoding techniques. In addition, the computational complexity for encoding and/or decoding may likewise be reduced thus reducing the power requirements.

The syntax and semantics may be in any suitable location, such as a slice header or picture parameter set or sequence parameter set or adaptation parameter set, and at any suitable location therein, such as for example as follows:

slice_header( ) {

first_slice_in_pic_flag
if( first_slice_in_pic_flag = = 0 )

slice_address

slice_type
entropy_slice_flag
if( !entropy_slice_flag ) {

pic_parameter_set_id
if( output_flag_present_flag )

pic_output_flag

if( separate_colour_plane_flag = = 1 )

colour_plane_id

if( slice_type = = C ) {

pic_order_cnt_lsb
copyslice_delta_poc_sign
copyslice_delta_poc_minus1

} else {

........

}

first_slice_in_pic_flag indicates whether the slice is the first slice of the picture.

slice_address specifies the address in slice granularity resolution in which the slice starts.

slice_type specifies the coding type of the slice.

entropy_slice_flag specifies whether the value of slice header syntax elements not present are inferred to be equal to the value of slice header syntax elements in a proceeding slice.

pic_parameter_set_id specifies the picture parameter set in use.

pic_output_flag affects the decoded picture output and removal processes.

separate_colour_plane_flag specifies whether that the three colour components of the 4:4:4 chroma format are coded separately.

color_plane_id specifies the colour plane associated with the current slice.

Thus if the slice_type is a C-slice {e.g., if(slice_type==C)} then the copy slice technique is used for those pixels.

The pic_order_cnt_lsb specifies the picture order count for the current picture modulo MaxPicOrderCntLsb for the current picture. When pic_order_cnt_lsb is not present, pic_order_cnt_lsb is inferred to be equal to 0. MaxPicOrderCntLsb may be defined as follows:

MaxPicOrderCntLsb=2^{(log2}^{_{—}}^{max}^{_{—}}^{pic}^{_{—}}^{order}^{_{—}}^{cnt}^{_{—}}^{lsb}^{_{—}}^{minus4+4)}

where log 2_max_pic_order_cnt_lsb_minus4 is syntax element in the bistream and specifies the value of the variable MaxPicOrderCntLsb that is used in the decoding process for picture order count. The value of log 2_max_pic_order_cnt_lsb_minus4 shall be in the range of 0 to 12, inclusive.

The copyslice_delta_poc_sign specifies the sign of the copyslice_delta_poc_minus1. A value of 0 indicates that the sign is positive and a value of 1 indicates that the sign is negative.

The copyslice_delta_poc_minus1 plus 1 specifies an absolute difference between two picture order count values, namely the offset to the picture having the data to be copied. The value of copyslice_delta_poc_minus1 is in the range of 0 to 2¹⁵−1, inclusive. In another embodiment, the copyslice_delta_poc_minus1 specifies an absolute difference between two picture order count values, namely the offset to the picture having the data to be copied. The value of copyslice_delta_poc_minus1 is in the range of 0 to 2¹⁵−1, inclusive. Therefore, the system may signal the same frame.

Accordingly, the slice header for a C-slice indicates whether the slice is a C-slice for the respective picture, a picture number associated with the respective picture, a direction of a future or a previous corresponding picture to obtain the corresponding pixel data, and the offset number to future or previous pictures where the corresponding pixel data is located. In general, the C-slice may be signaled in any manner and the desired picture to copy from may likewise be signaled or determined in any manner. The picture order count for the picture to be used for copying the pixel data may be calculated as: SrcPicOrderCntVal=PicOrderCntVal+copyslice_delta_poc_sign*(copyslice_delta_poc_minus1+1), where PicOrderCntVal identifies the picture order count of the current frame, where SrcPicOrderCntVal is the picture order count value of the source frame. In another embodiment, when the copyslice_delta_poc_minus1 specifies an absolute difference between two picture order count values, namely the offset to the picture having the data to be copied, the picture order count for the picture to be used for copying the pixel data may be calculated as: SrcPicOrderCntVal=PicOrderCntVal+copyslice_delta_poc_sign*(copyslice_delta_poc_minus1), where PicOrderCntVal identifies the picture order count of the current frame, where SrcPicOrderCntVal is the picture order count value of the source frame. The decoding may be based upon encoded pictures, such as a luminance sample array, and a pair of chrominance sample arrays.

In another embodiment, the slice_id syntax element is defined and included in the slice header to provide a unique identifier for each slice in a picture. For example, for a picture which consists of N slices, the slice_id may range from 0, 1, . . . , N−1. For the C-slice_type an additional syntax element copyslice_slice_id may be included in the slice header. In this case, the destination slice may be decoded by copying the sample values from the slice identified by the slice_id having a value of copyslice_slice_id in the frame SrcPicOrderCntVal. It is noted that the slice may be copied from another slice in the same picture. Also, the data may be consistent with the region defined by the copied slice.

The syntax and semantics of another embodiment may be in any suitable location, such as a slice header or picture parameter set or sequence parameter set or adaptation parameter set, and at any suitable location therein, such as for example as follows:

slice_header( ) {

first_slice_in_pic_flag
if( first_slice_in_pic_flag = = 0 )

slice_address

slice_type
slice_id
entropy_slice_flag
if( !entropy_slice_flag ) {

pic_parameter_set_id
if( output_flag_present_flag )

pic_output_flag

if( separate_colour_plane_flag = = 1 )

colour_plane_id

if( slice_type = = C ) {

pic_order_cnt_lsb
copyslice_delta_poc_sign
copyslice_delta_poc_minus1

copyslice_slice_id

} else {

........

}

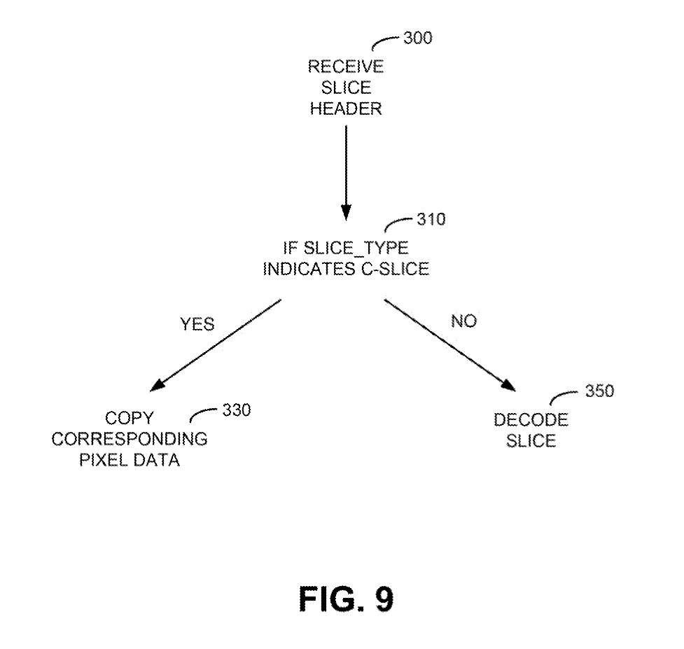

Referring to FIG. 9, the system may receive a slice header 300. If the slice_type indicates a C-slice 310, then the system copies corresponding pixel data from another or the same picture 330. If the slice_type does not indicate a C-slice 310, then the system decodes the slice 350 using any suitable technique. The slice_type may be included in a network abstraction layer unit, which is an encapsulation of coded slices into transport entities of the network. In general, any technique may be used to indicate whether or not a particular slice should copy pixel data from other pixels in the same or a different picture.

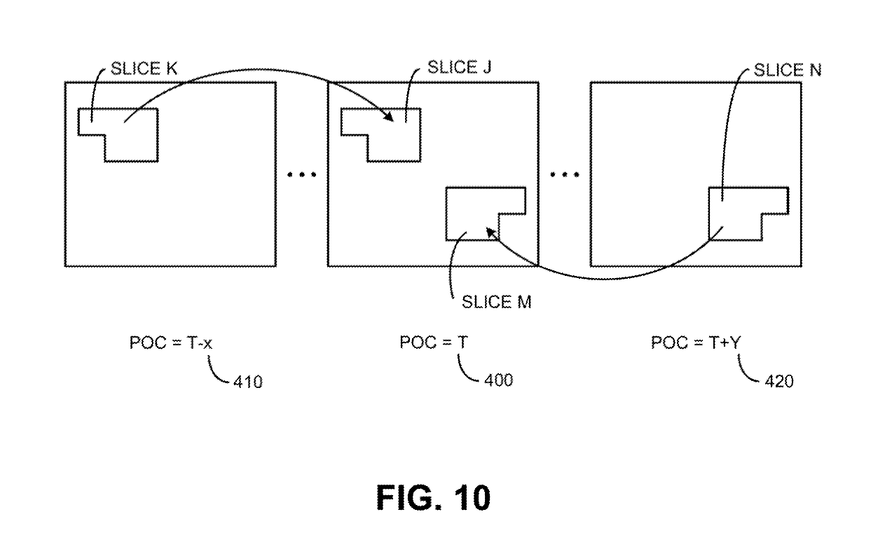

FIG. 10 illustrates the copying of pixel data from other frames and/or pixel data consistent with slices of other frames. For picture order count T 400, a slice J may be copied from a corresponding location of slice K from picture order count T−x 410. For picture order count T 400, a slice M may be copied from a corresponding location of slice N from picture order count T+y 420. In some cases, it may be desired to copy slice data for a slice from another slice within the same picture.

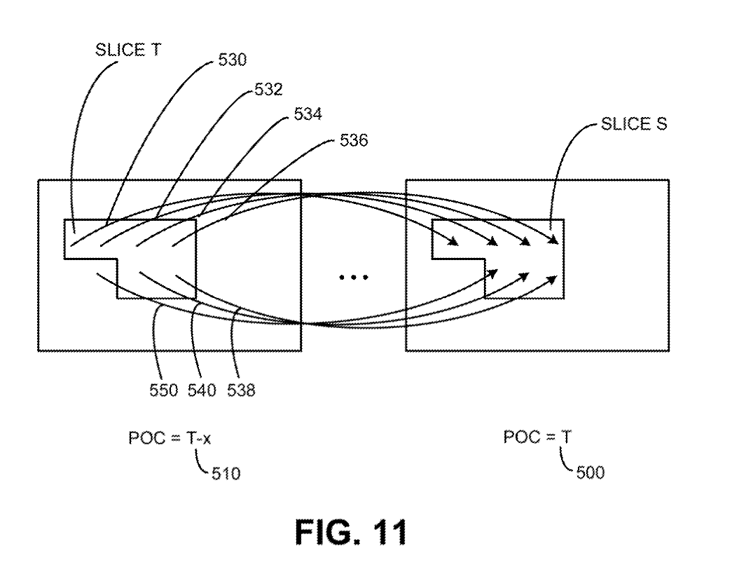

FIG. 11 illustrates the copying of pixel data from another frame consistent with the location of a slice in a current frame. For picture order count T 500, a slice S may be copied from a corresponding location partially included within slice T from picture order count T−x 510. The corresponding locations of 530, 532, 534, 536, 538, and 540 may be consistent between slices S and T. The corresponding locations copied for 550 may not be consistent between slices S and T. In some cases, it may be desired to copy slice data for a slice from another slice within the same picture.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding video comprising:
(a) receiving a frame of said video in a bitstream that includes at least one slice and at least one tile, where each of said at least one slice and said at least one tile are not all aligned with one another, wherein each of said at least one slice is characterized that it is decoded independently of the other said at least one slice, wherein each of said at least one tile is characterized that it is a rectangular region of said frame and having coding units for said decoding arranged in a raster scan order, wherein said at least one tile of said frame are collectively arranged in a raster scan order of said frame;
(b) receiving slice header data for at least one slice in said bitstream indicating that the pixel data of said slice is obtained from corresponding pixel locations in a different frame than the frame including said at least one slice.

2. The method of claim 1 wherein said frame includes a plurality of tiles, and each of said tiles are decoded in a manner that is independent of one another.

3. The method of claim 1 wherein said different frame includes a corresponding slice where the corresponding pixel locations are not consistent with said corresponding slice.

4. The method of claim 1 wherein said slice header includes the following syntax:
if( slice_type = = C ) {
pic_order_cnt_lsb
copyslice_delta_poc_sign
copyslice_delta_poc_minus1 }

5. The method of claim 4 wherein said pic_order_cnt_lsb specifies a picture order count for said at least one slice.

6. The method of claim 5 wherein said copyslice_delta_poc_minus1 specifies an absolute difference between two picture order count values.

7. The method of claim 6 wherein said copyslice_delta_poc_minus1 is in the range of 0 to 2¹⁵−1, inclusive.

8. The method of claim 7 wherein said copyslice_delta_poc_sign specifies the sign of said copyslice_delta_poc_minus1.

9. The method of claim 8 wherein a value of 0 for said copyslice_delta_poc_sign indicates a positive sign.

10. The method of claim 9 wherein a value of 1 for said copyslice_delta_poc_sign indicates a negative sign.
